(19) United States
(12) Patent Application Publication
(10) Pub. No.: US 2007/0116245 A1
(43) Pub. Date: May 24, 2007

(54) Device, a method, a computer program for telephone speed dialing

(75) Inventor: Kati Ala-Rantala, Tampere (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/281,305

(22) Filed: Nov. 16, 2005

(51) Int. Cl. H04M 1/00; H04M 3/00

(52) U.S. Cl. 379/355.01

(57) ABSTRACT

A mobile cellular telephone for speed dialling any one of a first plurality of different telephone numbers, the device including a user input device with a second plurality of user selectable actuators; means for associating any one of the actuators either with a telephone number or a respective subset of the first plurality of telephone numbers including multiple telephone numbers; and means responsive to the selection of an actuator which, if there is a telephone number associated with the selected actuator dials the telephone number and if there is a respective subset of the first plurality of telephone numbers associated with the selected actuator enables the dialling of one of the multiple telephone numbers in the subset by user selection of a respective one of the second plurality of actuators.

### FIELD OF THE INVENTION

Embodiments of the present invention relate to a device, a method, a computer program for enabling telephone speed dialing.

### BACKGROUND TO THE INVENTION

Typically in current mobile cellular telephones the keys of the ITU-T keypad can be associated with a telephone number of the user's choosing. When the telephone is in the idle state, selecting a key automatically dials the telephone number associated with the selected key. This functionality is commonly referred to as ‘speed dialing’ as a telephone number can be quickly called from the idle state.

A problem associated with speed dialing is that the total number of telephone numbers available for speed dialing cannot exceed the number of keys of the keypad.

It would be desirable to improve speed dialing.

### BRIEF DESCRIPTION OF THE INVENTION

According to one embodiment of the invention there is provided an electronic device for speed dialling any one of a first plurality of different telephone numbers, the device comprising: a user input device with a second plurality of user selectable actuators; means for associating any one of the actuators either with a telephone number or a respective subset of the first plurality of telephone numbers comprising multiple telephone numbers; and means responsive to the selection of an actuator which, if there is a telephone number associated with the selected actuator dials the telephone number and if there is a respective subset of the first plurality of telephone numbers associated with the selected actuator enables the dialling of one of the multiple telephone numbers in the subset by user selection of a respective one of the second plurality of actuators.

According to another embodiment of the invention there is provided a method for speed dialling any one of a first plurality of different telephone numbers using a second plurality of actuators, comprising: associating actuators either with a telephone number or a respective subset of the first plurality of telephone numbers comprising multiple telephone numbers; detecting user selection of an actuator; and if there is a telephone number associated with the selected actuator, dialling the telephone number, or if there is a respective subset of the first plurality of telephone numbers associated with the selected actuator, enabling the dialling of one of the multiple telephone numbers in the subset by user selection of a respective one of the second plurality of actuators.

According to another embodiment of the invention there is provided a computer program product embodying computer program instructions for associating actuators either with a telephone number or a respective subset of a first plurality of telephone numbers comprising multiple telephone numbers; detecting user selection of an actuator; and if there is a telephone number associated with the selected actuator, dialling the telephone number, or if there is a respective subset of the first plurality of telephone numbers associated with the selected actuator, enabling the dialling of one of the multiple telephone numbers in the subset by user selection of a respective one of the second plurality of actuators.

According to another embodiment of the invention there is provided an electronic device for speed dialling any one of a first plurality of different telephone numbers, the device comprising: a user input device with a second plurality of user selectable actuators; means for enabling a user to associate each telephone number with a user determined sequence of actuator selections; and means responsive to the selection of an actuator which, if there is a telephone number associated with the sequence of actuator selections terminating with the most recent actuator selection, dials the associated telephone number.

According to another embodiment of the invention there is provided a method for speed dialling any one of a first plurality of different telephone numbers using a second plurality of actuators, comprising: enabling a user to associate a telephone number with a user determined sequence of actuator selections; detecting user selection of an actuator; and if there is a telephone number associated with the sequence of actuator selections that terminates with the detected user selection, dialling the telephone number.

According to another embodiment of the invention there is provided a computer program product embodying computer program instructions for: enabling a user to associate a telephone number with a user determined sequence of actuator selections; detecting user selection of an actuator; and if there is a telephone number associated with the sequence of actuator selections that terminates with the detected user selection, dialling the telephone number.

According to another embodiment of the invention there is provided a device for performing one of a plurality of predefined actions using a data structure that has a root, at least a first level and a second, lower level and comprises a plurality of leaf nodes and branch nodes, where a branch node is not associated with a predefined action but has one or more dependent nodes at the next lowest level and where a leaf node is associated with a predefined action but cannot have any dependent nodes at the next lowest level, the root being an originally selected branch node, the device comprising: a user input device with a plurality of user selectable actuators; means for associating each node depending from the selected branch node with a different one of the actuators; and means responsive to the selection of an actuator which, if the node associated with the selected actuator is a leaf node, performs the predefined action associated with that leaf node and, if the node associated with the selected actuator is a branch node, selects the associated branch node.

### BRIEF DESCRIPTION OF THE DRAWINGS

For a better understanding of the present invention reference will now be made by way of example only to the accompanying drawings in which:

FIG. 1 schematically illustrates an electronic device 10

FIG. 2 illustrates a method of controlling speed dialling.

FIG. 3 illustrates a hierarchical nodular data structure; and

FIG. 4, illustrates a method of controlling the performance of predefined actions.

### DETAILED DESCRIPTION OF EMBODIMENTS OF THE INVENTION

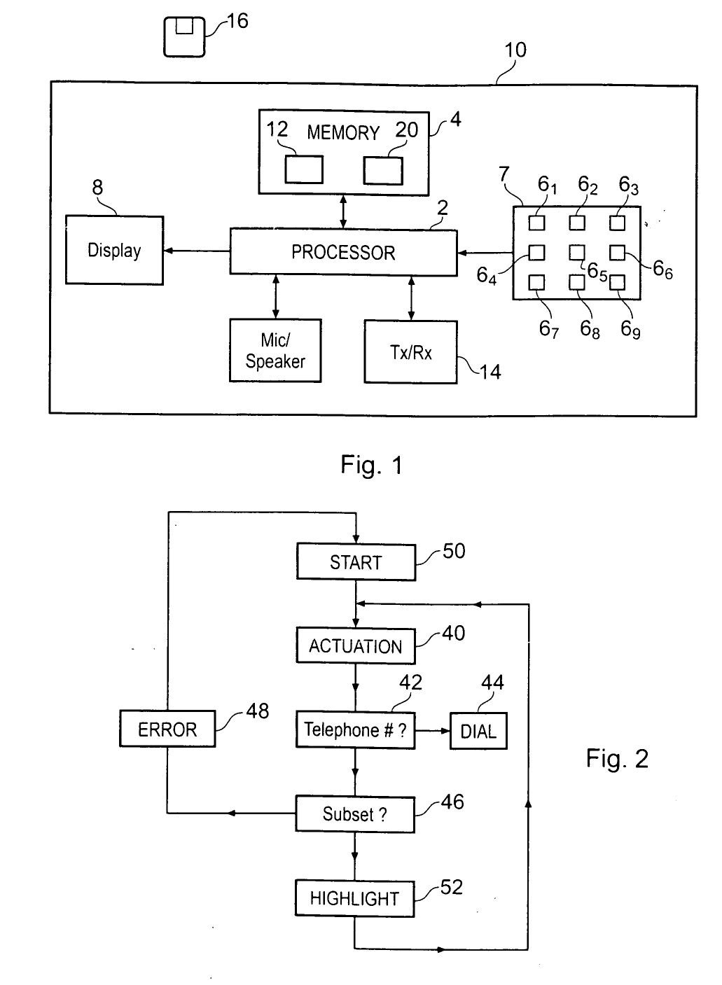

FIG. 1 schematically illustrates an electronic device 10 comprising a processor 2, a memory 4, a user input device 7 and a means for providing information to a user such as a display 8. Only as many components are displayed as is necessary to describe the following embodiments of the invention. It should be appreciated that additional components may be used in an implementation and that the illustrated components may be replaced by components that perform the same or similar functions.

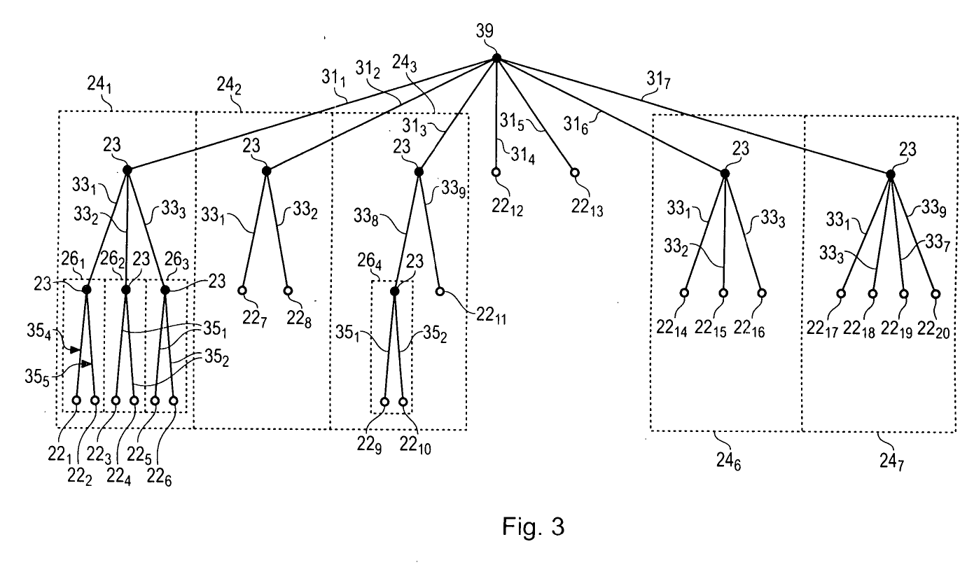

The processor 2 is connected to read from and write to the memory 4. The processor 2 is also connected to received input control signals from the user input device 7 and to provide output control signals to the display 8. The memory 4 stores a computer program 12 and a user programmable data structure 20, an example of which is illustrated in FIG. 3.

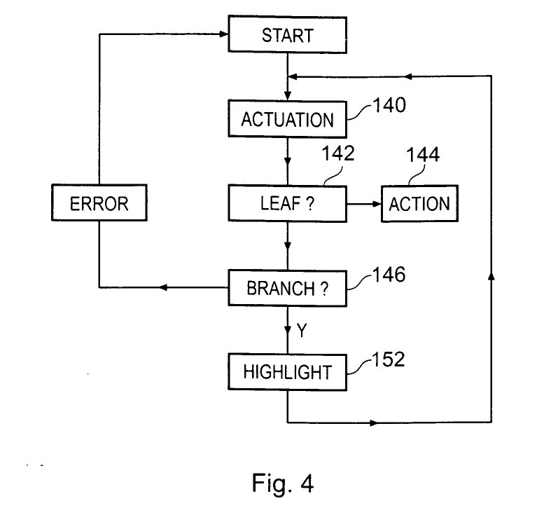

The computer program 12 comprises instructions that control the operation of the electronic device 10 when loaded into the processor 2. The computer program instructions provide the logic and routines that enables the electronic device to perform methods, for example, one or both of those illustrated in FIGS. 2 and 4. The computer program 12 may arrive at the electronic device 10 via an electromagnetic carrier signal (not shown) or be copied from a physical entity 16 such as a computer program product, a memory device or a record medium such as a CD-ROM or DVD.

The user input device 7 comprises a plurality of actuators 6. The input device 7 is not dedicated to the uses described below, but typically has multiple uses for example data entry.

The user input device 7, in one example, may be a keypad. In this example, each key of the keypad is an actuator 6. If the keypad is an ITU-T keypad, it has a 3 column by 4 row array of keys, including a 3 column by 3 row array of keys 1, 2, 3 . . . 9.

In another example, the user input device 7 may be an N-way joystick where a different actuator 6 detects when each one of the N ways is selected. In a further example, the user input device 7 may be a jog-wheel, where each actuator 7 detects the extent of rotation of the jog-wheel. In a still further example, the user input device 7 may use voice recognition to identify spoken code words each of which corresponds to an actuator. It should consequently be realised that an actuator 6 is something that responds to a trigger made by the user. Each of the different actuators has a different trigger but the actuators are not necessarily physically discrete.

In the following examples, reference is made to selection of an actuator 6. A selection may occur, for example, in response to a single actuation of an actuator 6. Alternatively, after a single actuation of an actuator, a dialog may be displayed asking a user to confirm the selection, with the selection occurring only after confirmation. As a further alternative, a single prolonged actuation of an actuator 6 e.g. pressing and holding a key for a threshold time such as 0.5 seconds, selects that actuator.

In the illustrated example, the electronic device 10 comprises additional radio frequency circuitry 14 that enables the device 10 to operate as a cellular mobile telephone or other radio telecommunications device. The radio frequency circuitry includes transceiver circuitry that provides data to the processor 2 and receives data from the processor. The data sent by the processor 2 to the transceiver circuitry enables it to set-up a radio communication channel, for example, the data may specify a telephone number to be dialed.

The mobile cellular telephone 10, additionally comprises a microphone and speaker 16 to enable spoken dialog over the set-up communication channel.

FIG. 2 illustrates a method of controlling speed dialling. Any one of a first plurality of different telephone numbers can be dialled by selecting one or more actuators. A data structure 20 is used to associate the actuator selections with respective telephone numbers 22. This data structure 20 may be a separate, downloadable module that the user can transfer between telephones. Consequently, when a user buys a new telephone, he does not need to manually re-program all the keys again but can simply transfer the data structure 20 to the new telephone.

The data structure 20, illustrated in FIG. 3, associates either a telephone number 22 or a set of multiple telephone numbers 24 with each of the actuators 6₁, 6₂ . . . 6₇. An actuator selection 31ₙ, where n corresponds to the subscript of the selected actuator, is associated with either a set of multiple telephone numbers or a telephone number.

The actuator selections 31ₙ, for n=1, 2, 3, 6 and 7, are associated with the respective different sets 24ₙ, of multiple telephone numbers. These selections are made when the device is in an idle state.

The actuator selection 31₄ is associated with the respective telephone number 22₁₂. The actuator selection 31₅ is associated with the respective telephone number 22₁₃.

Within each of the different sets 24ₙ, an actuator selection 33ₙ is associated with either a further set 26 of multiple telephone numbers or a telephone number 22.

Within each of the further sets 26 of telephone numbers, an actuator selection 35ₙ is associated with either another set of multiple telephone numbers or a telephone number 22, and so on.

The user is able to define the content of the telephone numbers 22 and also the arrangement of the data structure 20.

Thus the data structure 20 associates each telephone number 22 with a user determined sequence of actuator selections 31ₙ, 33ₙ and 35ₙ, where n identifies the actuator selected. The example data structure 20 in FIG. 3 defines the following associations of telephone numbers 22 to sequences of actuator selections.

| | Associated sequence of |
|---|---|
| | actuator selections for |
| Telephone number | dialling telephone number |
| 22₁ | 31₁ 33₁ 35₄ |
| 22₂ | 31₁ 33₁ 35₅ |
| 22₃ | 31₁ 33₂ 35₁ |
| 22₄ | 31₁ 33₂ 35₂ |
| 22₅ | 31₁ 33₃ 35₁ |
| 22₆ | 31₁ 33₃ 35₂ |
| 22₇ | 31₂ 33₇ |
| 22₈ | 31₂ 33₈ |
| 22₉ | 31₃ 33₈ 35₁ |
| 22₁₀ | 31₃ 33₈ 35₂ |
| 22₁₁ | 31₃ 33₉ |
| 22₁₂ | 31₄ |
| 22₁₃ | 31₅ |
| 22₁₄ | 31₆ 33₁ |
| 22₁₅ | 31₆ 33₂ |
| 22₁₆ | 31₆ 33₃ |
| 22₁₇ | 31₇ 33₁ |
| 22₁₈ | 31₇ 33₃ |
| 22₁₉ | 31₇ 33₇ |
| 22₂₀ | 31₇ 33₉ |

Referring back to FIG. 2, at step 40, a user selects an actuator 6ₙ.

Next at step 42, the processor 2 using the data structure 20, determines whether the actuator selection, in context, is associated with a telephone number 22 in the data structure 20.

The actuator selection, in context, is associated with a telephone number if a sequence of actuator selections terminating with that actuator selection is associated with a telephone number. For example, the telephone number 22₁₉ is associated with the sequence of actuator selections 31₇, 33₇.

If the actuator selection, in context, is associated with a telephone number 22 in the data structure 20, then the processor 2 at step 44 controls the radio frequency circuitry 14 to originate a telephone call using that telephone number.

If the actuator selection, in context, is not associated with a telephone number 22 in the data structure 20, then the processor at step 46 determines whether that actuator selection, in context, is associated with a set of multiple telephone numbers.

The actuator selection, in context, is associated with a set of multiple telephone numbers if the sequence of actuator selections terminating with that actuator selection is an initial part of sequences of actuator selections that are associated with respective telephone numbers. For example, the sequence of actuator selections associated with telephone numbers 22₁₄, 22₁₅, 22₁₆ share the common initial selection 31₆ and the sequence of actuator selections associated with telephone numbers 22₉, 22₁₀ share the common initial selection sequence 31₃, 33₈.

If the actuator selection, in context, is not associated with a set of multiple telephone numbers then at step 48 an error message is displayed and the method returns to the start 50.

If the actuator selection, in context, is associated with a set of multiple telephone numbers then at optional step 52 the actuators that can be validly actuated next are highlighted. For example, if keys are used as actuators, then the highlighting may be the illumination of the appropriate keys. As an example, referring to FIG. 3, starting from the root at level 0, the actuators 6₁, 6₂ . . . 6₇ are highlighted. The display 8 may also indicate the consequence of selecting the different actuators. If the actuator 6₇ is selected, then the actuators 6₁, 6₃, 6₇ and 6₉ are highlighted as they are respectively associated, in context, with the telephone numbers 22₁₇, 22₁₈, 22₁₉ and 22₂₀ Alternatively, if the actuator 6₃ is selected from the root, then the actuators 6₈ and 6₉ are highlighted as the actuator 6₉ is associated, in context, with the telephone number 22₁₁ and the actuator 6₈ is associated, in context, with the set of telephone numbers 26₄.

The highlighting of an actuator associated with a telephone number may be different to the highlighting of an actuator associated with a set of telephone numbers e.g. different colors may be used.

The method returns to step 140 to receive the next user input.

The data structure 20 allows telephone numbers that can be speed dialled to be grouped. For example, the set 24₁ may be a grouping of family telephone numbers and the set 24₇ may be a grouping of friends telephone numbers. As the data structure may be modified by the user, the user is able to arrange and organise the telephone numbers for speed dialling in convenient groupings.

The data structure 20 illustrated in FIG. 3 may, instead of being used for speed dialling, be used for performing other actions such as playing a music files as opposed to dialling telephone numbers or viewing pictures as opposed to dialling telephone numbers. The data structure 20 is a hierarchical nodular tree. The root 39 of the tree corresponds to the idle state of the device. The tree comprises leaf nodes 22 and branch nodes 23. The root 39 is a branch node. A branch node can have dependent child nodes at the next lowest level of the tree whereas a leaf node cannot. The dependent child nodes can be branch nodes, leaf nodes or a mixture of branch nodes and leaf nodes. A node can only be connected to a single ‘parent’ node in the next highest level.

Each node in each level of the tree is associated with an actuator, and each of the nodes that depend from the same parent node is associated with a different actuator.

Each leaf node is associated with a predefined action such as a ‘play function’ that plays a particular music file or ‘view function’ that views a particular image or a user programmed ‘macro’ for performing an action. In the previously described embodiment the predefined actions are speed dial functions that each dial a particular telephone number.

FIG. 4, illustrates a method of controlling the performance of an action such as ‘play’ or ‘view’. At step 140, a user selects an actuator 6ₙ.

Next at step 142, the processor 2 using the hierarchical tree 20, determines whether the actuator selection corresponds to a branch in the tree that terminates in a leaf node (step 142) or a branch node (step 146) or neither (step 146).

If the actuator selection corresponds to a branch in the tree that terminates in a leaf node 22 then the processor at step 144 performs a predefined action associated with the leaf node 22. e.g. play a particular mp3 file or view a particular picture.

If the actuator selection corresponds to a branch in the tree that terminates in a branch node 23 then the method moves to optional step 152. At step 152, the actuators that are associated with the child nodes depending from the terminating branch node are highlighted. The method returns to step 140 to receive the next user input.

If the actuator selection does not correspond to a branch in the tree processor 2 displays an error message (step 148) and the method returns to the start 150.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An electronic device for speed dialling any one of a first plurality of different telephone numbers, the device comprising:
a user input device with a second plurality of user selectable actuators;
means for associating any one of the actuators either with a telephone number or a respective subset of the first plurality of telephone numbers comprising multiple telephone numbers; and
means responsive to the selection of an actuator which, if there is a telephone number associated with the selected actuator dials the telephone number and if there is a respective subset of the first plurality of telephone numbers associated with the selected actuator enables the dialling of one of the multiple telephone numbers in the subset by user selection of a respective one of the second plurality of actuators.

2. An electronic device as claimed in claim 1, wherein the selection of the respective one of the second plurality of actuators is a first selection in a sequence of actuator selections.

3. An electronic device as claimed in claim 1, wherein the association of the actuators is user programmable.

4. An electronic device as claimed in claim 3, wherein whether an actuator is associated with a telephone number or a group of telephone numbers is user programmable.

5. An electronic device as claimed in claim 4, wherein the telephone number(s) are user programmable.

6. An electronic device as claimed in claim 1, wherein a first actuator is for association with a ‘friends’ subset of the first plurality of telephone numbers and a second actuator is for association with a ‘family’ subset of the first plurality of telephone numbers

7. An electronic device as claimed in claim 1, wherein, if an actuator is selected that is associated with a subset of the first plurality of actuators, then each of the actuators that is usable for selecting a telephone number of the subset for dialling is highlighted.

8. A method for speed dialling any one of a first plurality of different telephone numbers using a second plurality of actuators, comprising:
associating actuators either with a telephone number or a respective subset of the first plurality of telephone numbers comprising multiple telephone numbers;
detecting user selection of an actuator; and
if there is a telephone number associated with the selected actuator, dialling the telephone number, or
if there is a respective subset of the first plurality of telephone numbers associated with the selected actuator, enabling the dialling of one of the multiple telephone numbers in the subset by user selection of a respective one of the second plurality of actuators.

9. A method as claimed in claim 8, wherein the selection of the respective one of the second plurality of actuators is a selection in a sequence of actuator selections.

10. A method as claimed in claim 8, wherein the association of the actuators is user programmable.

11. A method as claimed in claim 10, wherein whether an actuator is associated with a telephone number or a group of telephone numbers is user programmable.

12. A method as claimed in claim 11, wherein the telephone number(s) are user programmable.

13. A method as claimed in claim 8, wherein, if an actuator is selected that is associated with a subset of the first plurality of actuators, then each of the actuators that is usable for selecting a telephone number of the subset for dialling is highlighted.

14. A computer program product embodying computer program instructions for associating actuators either with a telephone number or a respective subset of a first plurality of telephone numbers comprising multiple telephone numbers;
detecting user selection of an actuator; and
if there is a telephone number associated with the selected actuator, dialling the telephone number, or
if there is a respective subset of the first plurality of telephone numbers associated with the selected actuator, enabling the dialling of one of the multiple telephone numbers in the subset by user selection of a respective one of the second plurality of actuators.

15. An electronic device for speed dialling any one of a first plurality of different telephone numbers, the device comprising:
a user input device with a second plurality of user selectable actuators;
means for enabling a user to associate each telephone number with a user determined sequence of actuator selections; and
means responsive to the selection of an actuator which, if there is a telephone number associated with the sequence of actuator selections terminating with the most recent actuator selection, dials the associated telephone number.

16. A method for speed dialling any one of a first plurality of different telephone numbers using a second plurality of actuators, comprising:
enabling a user to associate a telephone number with a user determined sequence of actuator selections;
detecting user selection of an actuator; and
if there is a telephone number associated with the sequence of actuator selections that terminates with the detected user selection, dialling the telephone number.

17. A computer program product embodying computer program instructions for:
enabling a user to associate a telephone number with a user determined sequence of actuator selections;
detecting user selection of an actuator; and
if there is a telephone number associated with the sequence of actuator selections that terminates with the detected user selection, dialling the telephone number.

18. A device for performing one of a plurality of predefined actions using a data structure that has a root, at least a first level and a second, lower level and comprises a plurality of leaf nodes and branch nodes, where a branch node is not associated with a predefined action but has one or more dependent nodes at the next lowest level and where a leaf node is associated with a predefined action but cannot have any dependent nodes at the next lowest level, the root being an originally selected branch node, the device comprising:
a user input device with a plurality of user selectable actuators;
means for associating each node depending from the selected branch node with a different one of the actuators; and
means responsive to the selection of an actuator which, if the node associated with the selected actuator is a leaf node, performs a predefined action associated with that leaf node and,
if the node associated with the selected actuator is a branch node, selects the associated branch node.

19. A device as claimed in claim 18, wherein each of the plurality of predefined actions is the automatic dialling of a respective, predetermined telephone number.

20. A device as claimed in claim 18, wherein the data structure has a user configurable structure.

21. A device as claimed in claim 18, further comprising means for highlighting the actuators associated with the nodes depending from the selected branch node.

22. A device as claimed in claim 21, further comprising means for differentiating an actuator associated with a branch node and an actuator associated with a leaf node.

23. A device as claimed in claim 18, wherein the data structure is configurable to comprise:
a first branch node depending from the root branch node that has a first multiplicity of dependent nodes;
a second branch node depending from the root branch node that has a second multiplicity of dependent nodes; and
a third branch node depending from the root branch node that has a third multiplicity of dependent nodes,
wherein the first multiplicity, second multiplicity and the third multiplicity are different.

24. A device as claimed in claim 18, wherein the data structure is configurable to comprise:
a first branch node depending from the root branch node that has a first multiplicity of dependent nodes; and
a second branch node depending from the root branch node that has a second multiplicity of dependent nodes,
wherein the first multiplicity and the second multiplicity are less than the plurality of user selectable actuators.
